(19) United States
(12) Patent Application Publication
(10) Pub. No.: US 2017/0091669 A1
(43) Pub. Date: Mar. 30, 2017

(54) DISTRIBUTED PROCESSING SYSTEM, LEARNING MODEL CREATING METHOD AND DATA PROCESSING METHOD

(71) Applicant: FUJITSU LIMITED, Kawasaki-shi (JP)

(72) Inventors: Nobuyuki KUROMATSU, Kawasaki (JP); Haruyasu Ueda, Ichikawa (JP)

(73) Assignee: FUJITSU LIMITED, Kawasaki-shi (JP)

(21) Appl. No.: 15/251,729

(22) Filed: Aug. 30, 2016

(30) Foreign Application Priority Data
Sep. 30, 2015 (JP) 2015-195302

(51) Int. Cl. G06N 99/00; H04L 29/08

(52) U.S. Cl. CPC G06N 99/005; H04L 67/10

(57) ABSTRACT

A distributed processing system creates a learning model used for an update and sends the created learning model to a plurality of nodes in the distributed processing system. The distributed processing system distributes, to the nodes, application tinting information that is associated with the learning model used for the update sent to the nodes and that Is related to data that is the application target of the learning model used for the update. When the nodes receive the learning model used for the update and the application timing information, the nodes apply a learning model, which is obtained before the update, to the data associated with the lining that is before the application timing information. Furthermore, the nodes apply the learning model used for the update to the data associated with the timing that is after the application timing information.

### CROSS-REFERENCE TO RELATED APPLICATION

This application is based upon and claims the benefit of priority of the prior Japanese Patent Application No. 2015-195302, filed on Sep. 30, 2015, the entire contents of which are incorporated herein by reference.

### FIELD

The embodiment discussed herein is directed to a distributed processing system, a learning model creating method, a data processing method, and a computer-readable recording medium.

### BACKGROUND

In recent years, a technology of machine learning in big data has been drawing attention. Machine learning has two phases, i.e., a learning phase that creates a learning model by using various kinds of algorithms on the basis of training data and a prediction phase that predicts, by using the created learning model, an event that will occur in future. In general, in the learning phase, the accuracy of a learning model to be created is high as an amount of data that is used to create a learning model is increased. Due to this characteristic, machine learning in big data has been drawing attention as a technology that creates a learning model in a highly accurate manner.

Furthermore, because a lot of computational resources are used to create a learning model by using big data, a batch process that uses a parallel processing mechanism is used. In recent years, with the development

in the technology of in-memory processing, analytical processing of machine learning is carried out at a high speed and thus a technology that performs a prediction process in which a learning model that is previously created in the batch process is applied to real time input data has been drawing attention. In contrast to the real time input data, the mechanism that timely returns the processing result is referred to as a stream process.

For example, in the machine learning that uses a stream process, if the property of input data varies as the time has elapsed, because the input data that was used to create the learning model is not served as a reference, the accuracy of the result of the prediction process may sometimes he decreased. Thus, instead of continuously applying the same learning model, a learning model is periodically recreated by using the most recent input data and the learning model that is applied to the stream process is updated. Then, in the stream process, by collectively processing the input data in units of data to be subjected to predetermined processes, the learning model is updated at the timing at which the input data is switched in units of data to be processed. An example of collectively processing the input data in units of data to be subjected to predetermined processes includes, for example, a mini batch process that temporarily accumulates the input data, that performs a process at a frequency of about once every few seconds, and that returns the result. By using the mini batch process, it is possible to update the learning model while maintaining real time of the prediction process in the stream process.

Patent Document 1: Japanese Laid-open Patent Publication No. 2013-167985

Patent Document 2: Japanese Laid-open Patent Publication No. 06-067966

However, when the stream process is performed on a plurality of nodes in a distributed manner by using the mini batch process, there may be a case in which a learning model that is different from a learning model that needs to be primarily applied to the input data that is to be subjected to the distributed processing may possibly be applied. For example, there may be a case in which inconsistency of the timing between the input data and a learning model occurs, such as a case in which a node performs a process on the input data by applying an updated learning model at the timing at which an un-updated learning model needs to be used. If such an inconsistency of the timing between the input data and the learning model occurs, the accuracy of the result of the prediction process is consequently decreased.

### SUMMARY

According to an aspect of an embodiment, a distributed processing system includes, a plurality of nodes that stores allocated data in a buffer and that processes the data within predetermined time, which is obtained on the basis of a time stamp of the data, by applying a learning model to the data in units of a predetermined number of pieces of data stored in the buffer, a processor that executes a process comprising, a allocating the data to the plurality of nodes, creating, on the basis of input data, a learning model used for an update and sending the learning model used for the update at the creating to the plurality of nodes, distributing, to the plurality of nodes, application timing information that is associated with the learning model used for the update sent to the plurality of nodes at the sending and that is related to the time stamp of the data that is the application target of the learning model used for the update, wherein when the plurality of nodes receives the learning model used for the update and receives the application timing information, the plurality of nodes applies a learning model, which is obtained before the update, to the data associated with the timing that is before the application timing information and applies the learning model used for the update to the data associated with the timing that is after the application timing information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a distributed processing system according to an embodiment;

FIG. 2 is a schematic diagram illustrating an example of data targeted for the processing according to the embodiment;

FIG. 3 is a schematic diagram illustrating an example of data processing in units of mini batches according to the embodiment;

FIG. 4 is a flowchart illustrating an example of a learning model creating process according to the embodiment;

FIG. 5 is a flowchart illustrating an example of a prediction process according to the embodiment; and

FIG. 6 is a block diagram illustrating a computer that executes a program.

### DESCRIPTION OF EMBODIMENT

Preferred embodiments of the present invention will be explained with reference to accompanying drawings. The present invention is not limited to the embodiment. Furthermore, the embodiments may be used in any appropriate combination as long as the processes do not conflict with each other.

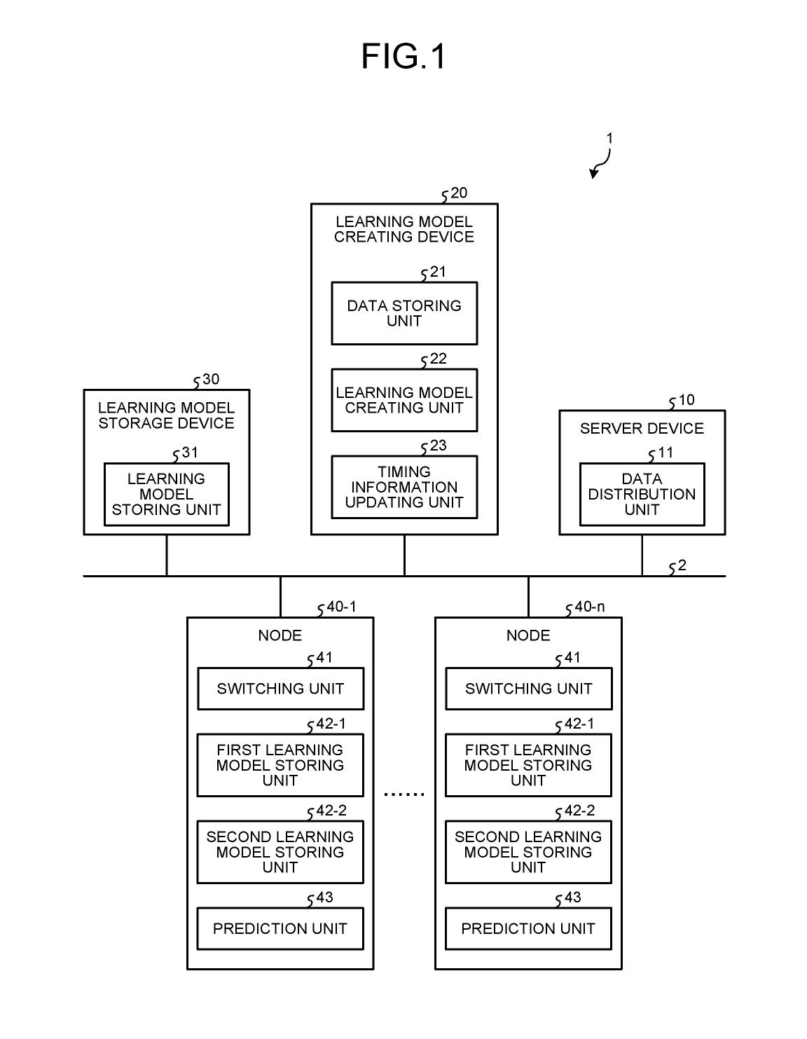

A distributed processing system according to the embodiment will be described. FIG. 1 is a schematic diagram illustrating a distributed processing system according to an embodiment. A distributed processing system 1 is a system that uses, for example, the lambda architecture.

The distributed processing system 1 includes a server device 10, a learning model creating device 20, a learning model storage device 30, and a plurality of nodes 40-1, . . . , and 40-n (n is a predetermined natural number). The plurality of nodes 40-1, . . . , and 40-n are collectively referred to as nodes 40. The server device 10, the learning model creating device 20, the learning model storage device 30, and the nodes 40 are connected such that these devices communicate with each other via a network 2. Any kind of communication network, such as a local area network (LAN), a virtual private network (VPN), or the like, may be used as the network 2 irrespective of whether the network is a wired or wireless connection.

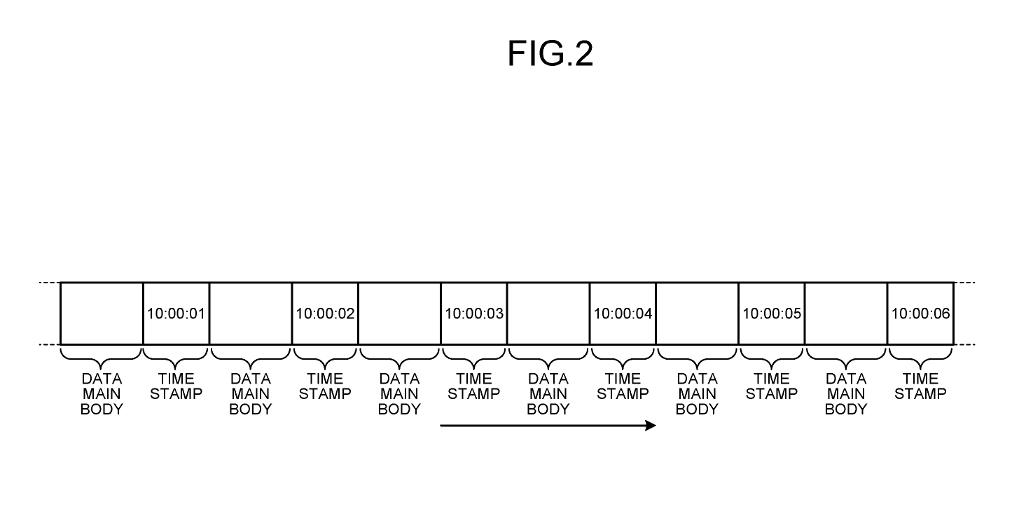

The server device 10 includes a data distribution unit 11. The data distribution unit 11 includes a data buffer. The data distribution unit 11 allocates, to one of the nodes 40, data that is received from outside via the network 2 or another network or data that is acquired from a predetermined file system that is not illustrated and then sends the data. Various kinds of existing scheduling technologies of the distributed processing system may be used for the method of the data distribution unit 11 allocating data to one of the nodes 40. FIG. 2 is a schematic diagram illustrating an example of data targeted for the processing according to the embodiment. As illustrated in FIG. 2, the data is a stream data to which a time stamp is attached for each data.

Furthermore, the data distribution unit 11 sends, to the learning model creating device 20, the data that is received from outside via the network 2 or another network or the data that is acquired from a predetermined file system that is not illustrated.

The learning model creating device 20 corresponds to, for example, the batch layer in the lambda architecture, performs a batch process, and creates a learning model. The learning model creating device 20 includes a data storing unit 21, a learning model creating unit 22, and a timing information updating unit 23. The learning model creating device 20 creates a learning model by using the batch process.

The data storing unit 21 is a file system that accumulates and stores therein the data received from the server device 10. The learning model creating unit 22 reads, if a predetermined condition for newly creating a learning model is satisfied, the data stored in the data storing unit 21, performs machine learning on the basis of this data, and creates a learning model. Creating a learning model is performed by using a predetermined existing method. Furthermore, the predetermined condition for creating a new learning model is, for example, a case in which a predetermined time has elapsed after the learning model was created last time, a case in which the prediction accuracy obtained from the stream process that applies the learning model is decreased by an amount equal to or less than a predetermined amount, as will be described later, or the like. The learning model creating unit 22 sends the created learning model to the learning model storage device 30.

When the learning model is created by the learning model creating unit 22, the timing information updating unit 23 creates timing information that is associated with the created learning model. Then, the timing information updating unit 23 sends the created timing information to the learning model storage device 30.

The learning model storage device 30 associates the learning model that is created by the learning model creating unit 22 with the timing information that is created by the timing information updating unit 23 and that is associated with the subject learning model and then stores therein the learning model associated with the timing information. Furthermore, the timing information is, for example, a time stamp that indicates the time at which the associated learning model is applied to the data that is the processing target. Furthermore, creating the timing information is performed by using various kinds of existing methods.

The learning model storage device 30 is, for example, a distribution memory file system that stores therein the learning models and the timing information created by the learning model creating device 20 and that guarantees inseparability of data and consistency of data. Furthermore, in FIG. 1, for the sake of simplicity, the single learning model storage device 30 is illustrated; however, the learning models may also be stored in a plurality of learning model storage devices. The learning model storage device 30 includes a learning model storing unit 31. The learning model storing unit 31 is a storing unit for high speed access, such as a random access memory (RAM) or the like. The learning model storing unit 31 associates the learning model that is created by the learning model creating unit 22 with the timing information that is created by the timing information updating unit 23 and that is associated with the subject learning model and then stores therein the learning model and the associated timing information. The learning model storage device 30 stores therein both the latest learning model and the timing information that is associated with the subject learning model.

The nodes 40 are data processing devices that correspond to, for example, the speed layer of the lambda architecture and that performs a prediction process that applies a learning model to the data by using the stream process. The nodes 40 are computational resources, such as servers or the like. Each of the nodes 40 includes a switching unit 41, a first learning model storing unit 42-1, a second learning model storing unit 42-2, and a prediction unit 43. The first learning model storing unit 42-1 stores therein a learning model and the associated timing information that are used by the prediction unit 43 for the prediction process. Hereinafter, the learning model stored by the first learning model storing unit 42-1 is sometimes referred to as an old learning model. Furthermore, the second learning model storing unit 42-2 stores therein the latest learning model and the associated timing information that are created by the learning model creating device 20. The first learning model storing unit 42-1 and the second learning model storing unit 42-2 are storage devices, such as RAMs or the like. The first learning model storing unit 42-1 and the second learning model storing unit 42-2 may also be a physically integrated single storage device.

The switching unit 41 compares an MD5 message-digest algorithm of the learning model that is stored in the learning model storing unit 31 in the learning model storage device 30 with the MD5 of the learning model that is stored in the first learning model storing unit 42-1. Then, if the MD5 of the learning model stored in the learning model storing unit 31 is different from that stored in the first learning model storing unit 42-1, the switching unit 41 acquires the latest learning model and the associated timing information that are stored in the learning model storing unit 31. Then, the switching unit 41 stores the acquired latest learning model and the associated timing information in the second learning model storing unit 42-2. Furthermore, comparing the learning model that is stored in the learning model storing unit 31 in the learning model storage device 30 with the learning model that is stored in the first learning model storing unit 42-1 is not limited to comparing the MD5 and comparing various kinds of existing data or checking methods may also be used.

Furthermore, the switching unit 41 compares the time stamp that is attached to the data received from the server device 10 with the learning model that is stored in the first learning model storing unit 42-1 and that is associated with the timing information. If the switching unit 41 determines, from the comparison result, that the learning model that is applied to the data received from the server device 10 is the latest learning model that is stored in the second learning model storing unit 42-2, the switching unit 41 discards the learning model stored in the first learning model storing unit 42-1. Then, the switching unit 41 allows the first learning model storing unit 42-1 to store therein the latest learning model that is stored in the second learning model storing unit 42-2.

The prediction unit 43 is a processing unit that performs a prediction process by applying the learning model stored in the first learning model storing unit 42-1 to a mini batch received from the server device 10. The prediction unit 43 includes a data buffer. Then, if the number of pieces of data that are received front the data distribution unit 11 in the server device 10 and that are stored in the buffer reaches a predetermined number corresponding to a window, for example, if the number of pieces of data each having a time stamp of one second becomes 5, the prediction unit 43 outputs the data from the data buffer in units of windows. Then, the prediction unit 43 performs the prediction process on the data output from the data buffer by applying the learning model stored in the first learning model storing unit 42-1. Furthermore, the data in units of windows is referred to as a mini batch. Furthermore, the data processing that is performed in units of windows is referred to as a mini batch process.

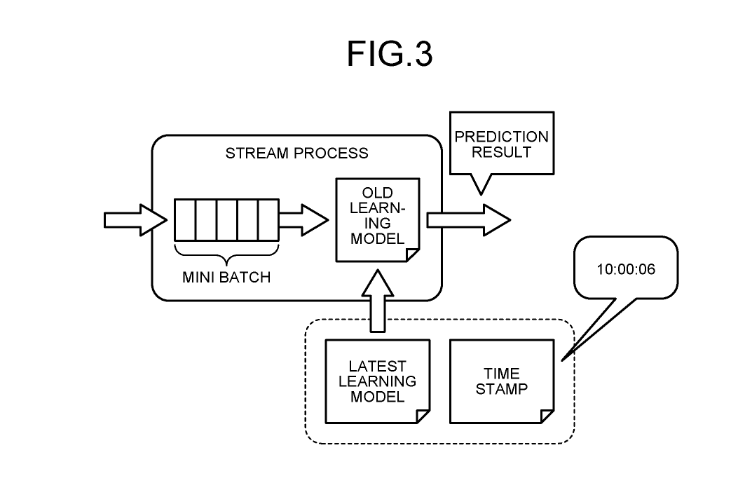

FIG. 3 is a schematic diagram illustrating an example of data processing in units of mini batches according to the embodiment. The data that is the processing target in the embodiment is, as illustrated in FIG. 2, a single piece of data in the order of the time stamp and the data main body. In the embodiment, in the stream process performed by the node 40, data is processed in units of mini batches of window with, for example, the width of five seconds. As illustrated in FIG. 3, in the stream process, if it is detected that the latest learning model has been received, the time stamp “10:00:06” that is associated with the latest learning model is read. Then, in the stream process, it is recognized that the learning model needs to be applied to the pieces of data that hold the time stamp of “10:00:06” and the subsequent time stamps.

However, in the stream process, as illustrated in FIG. 2, if the time stamps of the pieces of data that are the processing target are “10:00:01” to “10:00:05”, the pieces of data are processed by using the old learning model. Then, after the end of the mini batch process performed on the time stamps “10:00:01” to “10:00:05” and before the start of the mini batch processes at the time stamp of “10:00:06” and the subsequent time stamps, the latest learning model is loaded from the second learning model storing unit 42-2 to the first learning model storing unit 42-1. In the stream process that is performed in all of the nodes 40, the latest learning model is applied in this way described above on the data targeted for the processing. Consequently, the same learning model may be applied to the data that has the same time stamp even in different stream processes in parallel distributed processing.

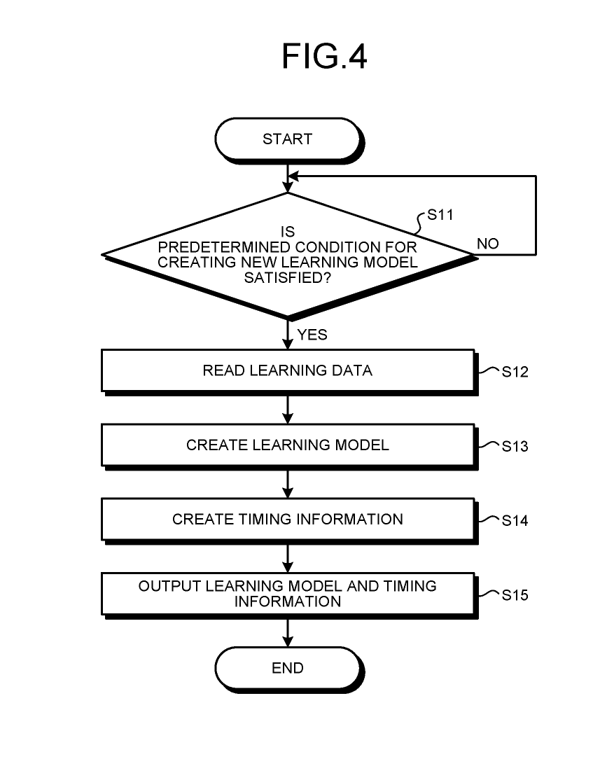

FIG. 4 is a flowchart illustrating an example of a learning model creating process according to the embodiment. The learning model creating process is a batch process that is repeatedly performed by the learning model creating device 20. First, the learning model creating unit 22 determines whether the predetermined condition for creating a new learning model is satisfied (Step S11).

Here, the predetermined condition for newly creating a learning model is, for example, a case in which a predetermined time has elapsed after the learning model was created last time, a case in which the prediction accuracy obtained from the stream process that applies the learning model is decreased by an amount equal to or less than a predetermined amount, as will be described later, or the like. The case in which the prediction accuracy is decreased by an amount equal to or less than a predetermined amount indicates that deviation equal to or greater than a predetermined amount is present between the predict ion result (a predicted value) that is obtained from the stream process per formed by the node 40 and the data (an actual measurement value) that is arrived later. For example, if a difference between the predicted value and the actual measurement value exceeds a predetermined threshold, it is recognized that the property of the input data has been varied. For the predetermined threshold, an appropriate value may be used in accordance with the target for the analysis or the measurement.

If the learning model creating unit 22 determines that the predetermined condition for newly creating a learning model is satisfied (Yes at Step S11), the learning model creating unit 22 proceeds to Step S12. In contrast, if the learning model creating unit 22 determines that the predetermined condition for newly creating a learning model is not satisfied (No at Step S11), the learning model creating unit 22 repeats the process at Step S11.

At Step S12, the learning model creating unit 22 reads, from the data storing unit 21, the data for the learning by an amount corresponding to a predetermined time period. Then, the learning model creating unit 22 creates a learning model on the basis of the data that is read at Step S12 and that is used for the learning (Step S13). Then, the timing information updating unit 23 creates the timing information that is associated with the learning model that is created by the learning model creating unit 22 at Step S13 (Step S14). Then, the learning model creating unit 22 and the timing information updating unit 23 outputs the created learning model and the associated timing information to the learning model storage device 30 (Step S15).

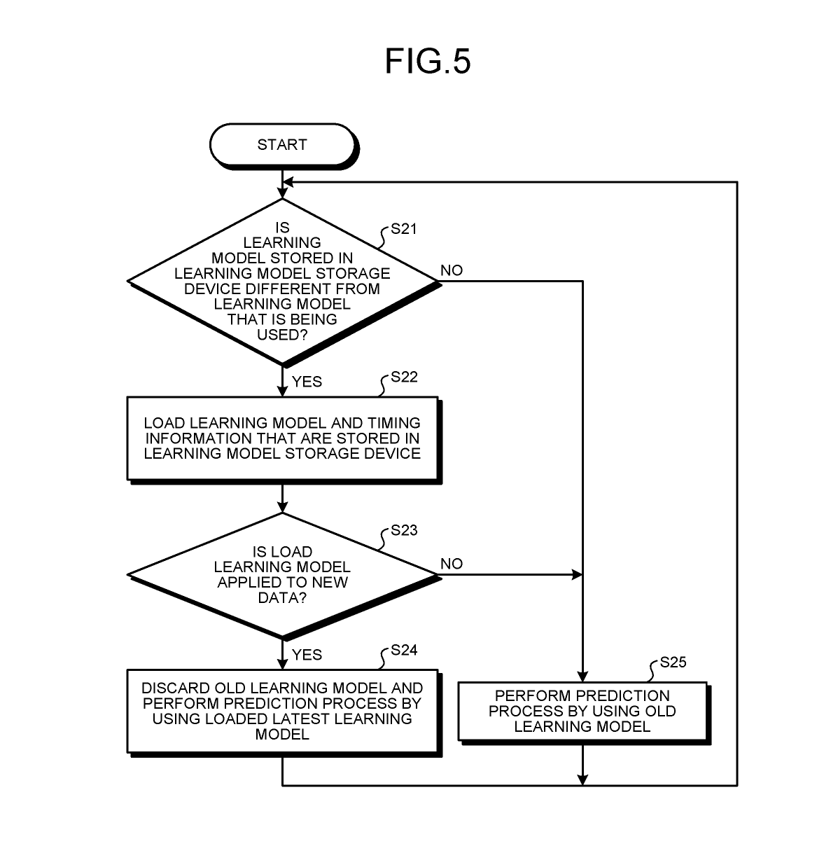

FIG. 5 is a flowchart illustrating an example of a prediction process according to the embodiment. The prediction process is a stream process that is repeatedly performed by each of the nodes 40. First, the switching unit 41 compares the MD5 of the learning model stored in the learning model storage device 30 with the MD5 of the learning model that is being used, i.e., the learning model stored in the first learning model storing unit 42-1, and determines whether the two models are different (Step S21). If the two models are different (Yes at Step S21), the switching unit 41 proceeds to Step S22. In contrast, if the two models are the same (No at Step S21), the switching unit 41 proceeds to Step S25.

At Step S22, the switching unit 41 loads both the learning model and the associated timing information that are stored in the learning model storage device 30 and allows the second learning model storing unit 42-2 to store the loaded learning model and the associated timing information. Then, the switching unit 41 compares the timing information loaded at Step S22 with the time stamp of the data that is the processing target and determines whether the data is to be processed by applying the latest learning model (Step S23). If the switching unit 41 determines that the data needs to be processed by applying the latest learning model (Yes at Step S23), the switching unit 41 proceeds to Step S24. In contrast, if the switching unit 41 determines that the data needs to be processed by applying the old learning model (No at Step S23), the switching unit 41 proceeds to Step S25.

At Step S24, the switching unit 41 discards the old learning model stored in the first learning model storing unit 42-2 and allows the first learning model storing unit 42-1 to store the latest learning model that is stored in the second learning model storing unit 42-2. Then, the switching unit 41 performs the prediction process on the data that is the processing target by applying the latest learning model (Step S24). After the end of Step S24, the node 40 proceeds to Step S21.

In contrast, at Step S25, the switching unit 41 performs the prediction process on the data that is the processing target by applying the old learning model that is stored in the first learning model storing unit 42-1. After the end of Step S25, the node 40 proceeds to Step S21.

According to the embodiment described above, in the machine learning performed in real time, the latest learning model is applied, without damaging real time in the stream process, with respect to the variation in the property (tendency) of data that is generated in accordance with the elapsed time and it is possible to reduce a decrease in the accuracy of prediction result.

Furthermore, according to the embodiment described above, by creating a learning model independently of the stream process and by separating the stream processing unit and the storing unit in which the latest learning models are stored, the latest learning model is appropriately applied in accordance with the property (tendency) of data. Furthermore, because the storing unit that stores therein the latest learning models is a distributed memory file system in which the consistency of data is guaranteed, it is possible to suppress the overhead when the learning model is updated in the mini batch process. Furthermore, in the distributed stream process, it is possible to avoid the occurrence of the state in which learning models that are used for each node are different.

Furthermore, in the embodiment described above, the latest learning model is stored in the learning model storing unit 31 in the Learning model storage device 30. However, the disclosed technology is not limited to this and the latest learning model may also be stored in the same file system as a file system (not illustrated) that acquires data that is the processing target.

Furthermore, in the embodiment described above, the learning model creating unit 22 sends the created learning model to the learning model storage device 30 and allows the learning model storage device 30 to store therein the created learning model. Furthermore, the learning model stored in the learning model storage device 30 is acquired by the node 40. However, the disclosed technology is not limited to this and the learning model creating unit 22 may also send the created learning model to the node 40.

Furthermore, in the embodiment described above, the timing information updating unit 23 sends the created timing information to the learning model storage device 30 and allows the learning model storage device 30 to store therein the created timing information. Furthermore, the timing information stored in the learning model storage device 30 is acquired by the node 40. However, the disclosed technology is not limited to this and the timing information updating unit 23 may also send the created timing information to the node 40. Alternatively, if the timing information updating unit 23 sends the created timing information to the node 40, the data distribution unit 11 in the server device 10 may also send the timing information to the node 40 together with the data that is to be sent to the node 40.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device may be configured by functionally or physically separating or integrating any of the units depending on various loads or use conditions. For example, the server device 10 according to the embodiment described above may also be integrated with the learning model creating device 20.

For example, each of the processing units, i.e., the learning model creating unit 22 and the timing information updating unit 23 illustrated in FIG. 1, may also be integrated as a single unit. Furthermore, for example, each of the processing units, i.e., the switching unit 41 and the prediction unit 43 illustrated in FIG. 1 may also be integrated as a single unit. Furthermore, for example, each of the processing units, i.e., the first learning model storing unit 42-1 and the second learning model storing unit 42-2 illustrated in FIG. 1 may also be integrated as a single unit. Furthermore, the processes performed by the processing units may also appropriately be separated into processes performed a plurality of processing units. Furthermore, all or any part of the processing functions performed by each of the processing units may be implemented by a CPU and by programs analyzed and executed by the CPU or implemented as hardware by wired logic.

### Program

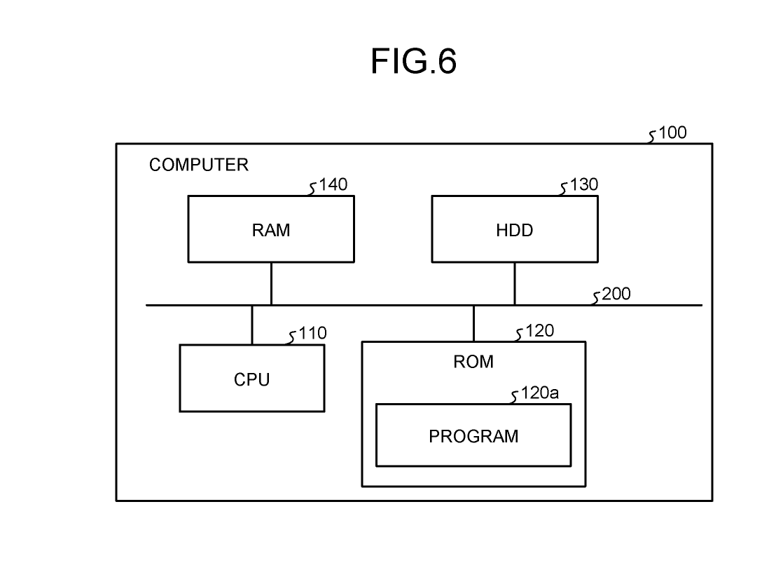

Furthermore, various kinds of processes described in the above embodiment may be implemented by executing programs prepared in advance for a computer system, such as a personal computer or a workstation. Accordingly, in the following, a description will be given of an example of a computer system that executes a program having the same function as that performed in the embodiment described above. FIG. 6 is a block diagram illustrating a computer that executes a program.

As illustrated in FIG. 6, a computer 100 includes a central processing unit (CPU) 110, a read only memory (ROM) 120, a hard disk drive (HDD) 130, and a random access memory (RAM) 140. Each of the units 110 to 140 is connected via a bus 200. Furthermore, instead of the HDD 130, an external storage device, such as a solid state drive (SSD), a solid state hybrid drive (SSHD), a flash memory, or the like, may also be used.

For example, when the computer 100 implements the same function as that performed by the server device 10 according to the embodiment described above, a program 120a that is stored in the ROM 120 in advance is a data distribution program or the like. Furthermore, for example, when the computer 100 implements the same function as that performed by the learning model creating device 20 according to the embodiment described above, the program 120a that is stored in the ROM 120 in advance is a learning model creating program, a timing update program, or the like. Furthermore, for example, when the computer 100 implements the same function as that performed by the node 40 according to the embodiment described above, the program 120a that is stored in the ROM 120 in advance is a switching program, a prediction program, or the like. Furthermore, each of the programs 120a stored in the ROM 120 in advance may also appropriately be integrated and separated.

Then, the CPU 110 reads each of the programs 120a from the ROM 120 and executes the programs 120a, whereby the CPU 110 executes the same operation as that executed by each of the processing units according to the embodiment described above. Namely, the CPU 110 executes the data distribution program, whereby the CPU 110 executes the same operation as that executed by the data distribution unit 11 according to the embodiment described above. Furthermore, the CPU 110 executes the learning model creating program and the timing update program, whereby the CPU 110 executes the same operation as those executed by the learning model creating unit 22 and the timing information updating unit 23, respectively, according to the embodiment described above. Furthermore, the CPU 110 executes the switching program and the prediction program, whereby the CPU 110 executes the same operation as those executed by the switching unit 41 and the prediction unit 43, respectively, according to the embodiment described above.

Furthermore, the programs 120a described above do not need to be stored in the ROM 120 from the beginning. The programs 120a may also be stored in the HDD 130.

For example, the programs 120a are stored in a “portable physical medium”, such as a flexible disk (FD), a CD-ROM, a DVD disk, a magneto-optic disk, an IC CARD, or the like, that is to be inserted into the computer 100. Then, the computer 100 may also read and execute these programs from the portable physical medium.

Furthermore, the programs may also foe stored in “another computer (or a server)” connected to the computer 100 via a public circuit, the Internet, a LAN, a WAN, or the like. Then, the computer 100 may also read and execute the programs from the other computer.

It is possible to prevent the accuracy of the result of a prediction process, which is performed by using

learning models that are obtained from the stream process, from being decreased due to inconsistency of the timing between input data and the learning models.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A distributed processing system comprising:
a plurality of nodes that stores allocated data in a buffer and that processes the data within predetermined time, which is obtained on the basis of a time stamp of the data, by applying a learning model to the data in units of a predetermined number of pieces of data stored in the buffer;
a processor that executes a process comprising;
allocating the data to the plurality of nodes;
creating, on the basis of input data, a learning model used for an update;
sending the learning model used for the update at the creating to the plurality of nodes; and
distributing, to the plurality of nodes, application timing information that is associated with the learning model used for the update sent to the plurality of nodes at the sending and that is related to the time stamp of the data that is the application target of the learning model used for the update, wherein
when the plurality of nodes receives the learning model used for the update and the application timing information, the plurality of nodes applies a learning model, which is obtained before the update, to the data associated with the timing that is before the application timing information and applies the learning model used for the update to the data associated with the timing that is after the application timing information.

2. The distributed processing system according to claim 1, wherein the the distributing includes distributing the application timing information together with the data that is allocated to the nodes at the allocating.

3. The distributed processing system according to claim 1, wherein each of the plurality of nodes reads the learning model used for the update from a distributed file system that has inseparability of data and consistency of data.

4. A learning model creating method comprising:
creating, by a computer processor, a learning model used for an update on the basis of input data;
sending the learning model used for the update to a plurality of nodes that processes the data within predetermined time, which is obtained on the basis of a time stamp of the data, by applying the learning model used for the update to the data; and
distributing, to the plurality of nodes, application timing information that is associated with the learning model used for the update sent to the plurality of nodes and that is related to the time stamp of the data that is the application target of the learning model used for the update.

5. A data processing method comprising:
storing, by a computer processor, reception data in a buffer;
processing the reception data within predetermined time, which is obtained on the basis of a time stamp of the reception data, by applying a learning model to the reception data in units of a predetermined number of pieces of reception data stored in the buffer;
receiving a learning model used for an update and application timing information that is associated with the learning model used for the update and that is related to the time stamp of the reception data that is the application target of the learning model used for the update; and
switching the learning model that is applied to the reception data such that the learning model, which is obtained before the update, is applied to the reception data that is associated with the timing that is before the application timing information and the learning model used for the update is applied to the reception data that is associated with the timing that is after the application timing information.

6. A non-transitory computer-readable recording medium having stored therein a learning model creating program that causes a computer to execute a process comprising:
creating, on the basis of input data, a learning model used for an update;
sending the learning model used for the update to a plurality of nodes that processes the data within predetermined time, which is obtained on the basis of a time stamp of the data, by applying the learning model used for the update to the data; and
distributing, to the plurality of nodes, application timing information that is associated with the learning model used for the update sent to the plurality of nodes and that is related to the time stamp of the data that is the application target of the learning model used for the update.

7. A non-transitory computer-readable recording medium having stored therein a data processing program that causes a computer to execute a process comprising:
storing reception data in a buffer and processing the reception data within predetermined time, which is obtained on the basis of a time stamp of the reception data, by applying a learning model to the reception data in units of a predetermined number of pieces of reception data stored in the buffer;
receiving a learning model used for an update and application timing information that is associated with the learning model used for the update and that is related to the time stamp of the reception data that is the application target of the learning model used for the update; and
switching the learning model that is applied to the reception data such that the learning model, which is obtained before the update, is applied to the reception data that is associated with the timing that is before the application timing information and the learning model used for the update is applied to the reception data that is associated with the timing that is after the application timing information.
